(19) United States
(12) Patent Application Publication
(10) Pub. No.: US 2010/0152340 A1
(43) Pub. Date: Jun. 17, 2010

(54) METHOD AND APPARATUS FOR PRODUCING POLYMER FILM, POLYMER FILM, POLARIZING PLATE AND LIQUID CRYSTAL DISPLAY

(76) Inventor: Kazuhide Kanemura, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 12/088,666

(22) PCT Filed: Sep. 26, 2006
(86) PCT No.: PCT/JP2006/319644

§ 371 Date: Mar. 28, 2008

(30) Foreign Application Priority Data
Sep. 28, 2005 (JP) 2005-282158

(51) Int. Cl. C08K 5/3475; B29D 7/01; B29C 39/14; G02B 5/30

(52) U.S. Cl. 524/91; 264/216; 425/224

(57) ABSTRACT

A dope including a polymer and a solvent is prepared. The dope is casted from a casting die (43) to a casting belt (46) with forming a casting bead (100), to form a casting film (69). The decompression chamber (68) is provided behind the casting bead (100). An area including the casting die (43) and the decompression chamber (68) is partitioned as a casting section (105) from other sections by a first partition (102) and a second partition (103). A volume of the casting section (105) is set in a range of 0.80 m³ to 300.00 m³. Inside the casting section (105) is decompressed by a decompression chamber (68) while a fluctuation of air pressure is less than 2.00 Pa. A wind shielding member 101 is provided between the casting die (43) and the decompression chamber (68), to shield wind from behind the casting bead (100).

### TECHNICAL FIELD

The present invention relates to a method and an apparatus for producing polymer film, a polymer film, a polarizing plate and a liquid crystal display.

### BACKGROUND ART

As methods for producing a polymer film used as an optical film, there are a solution casting method and a melt extrusion method. The melt extrusion method has an advantage in high productivity and low cost for a production apparatus, because polymers are melted and then extruded from an extruder to produce the film. However, in this method, it is difficult to control accuracy of the film thickness, and minute streaks (die lines) are generated on the film. Accordingly, it is difficult to produce the film with high quality sufficient to be used as the optical film.

In the solution casting method, polymers are dissolved to a solvent to prepare a polymer solution (dope), and the dope is cast on a moving support to form a casting film in a casting section. Then the casting film is peeled from the support as a wet film after having a self-supporting property, and dried so as to become a film. The film produced in this method is more excellent in optical isotropy and uniformity of thickness and has less foreign particles than that obtained in the melt extrusion method. Accordingly, the film is used for optoelectronics, such as a protective film for a polarizing filter, a retardation film, a transparent conductive film and the like. For above reasons, recently most of the optical film is produced by the solution casting method.

When a film of 20 μm to 200 μm thickness is produced by the solution casting method, a thickness unevenness in a direction of casting possibly generates on a surface of the casting film on the support, which causes “lateral stripes” (a film failure in which the film is undulated in the casting direction so that the film appears to have stripes in the width direction). A reason for the above problem is that a casting bead, which is the dope discharged from a casting die, receives air vibration in the periphery. The thickness unevenness is highly visible, and considerably affects the quality of the film. Especially, the thickness unevenness is the large problem when the film is used as the protective film for a polarizing filter, or an optical compensation film, since the liquid crystal display having high-resolution and high-definition is required. Accordingly, the requirement of reducing the thickness unevenness is rising each year.

To reduce the thickness unevenness, there are a method in which a decompression chamber is provided in a casting section and the structure of the decompression chamber is optimized (for example in JP-A-6-155494), a method in which at least two different contact member are provided near a position on a support (dope landing point) where casting dope (casting bead) lands (for example in JP-A-2000-202842), and a method in which a wind shielding member is provided at a certain position such as behind the casting bead (for example in JP-A-2004-114328).

However, in the method of JP-A-6-155494, although the thickness unevenness on the edge portions of the film can be reduced by preventing flow of the air into the casting section, it is difficult to reduce the thickness unevenness periodically generated on whole area of the film. In the method of JP-A-2000-202842, although transmission of fluctuation of air pressure from the decompression chamber to the casting dope can be prevented, it is difficult to reduce the thickness unevenness caused by fluctuation of air pressure generated around the casting dope. In the method of JP-A-2004-114328, it can be prevented that accompanying wind, which is generated by movement of the support, from behind the casting dope contacts the casting dope. Accordingly, the thickness unevenness on the surface of the casting film can be prevented in certain degree. However, it is difficult to produce the film having the quality which satisfies the rising demand for high-resolution and high-definition.

An object of the present invention is to provide a method and an apparatus for producing polymer film, in which a polymer film having superior thickness uniformity is produced by reducing thickness unevenness periodic in a casting direction of the casting film, and a polymer film, a polarizing plate and a liquid crystal display produced by this method.

### DISCLOSURE OF INVENTION

In order to achieve the object and other objects, a method of the present invention for producing a polymer film comprises a step of discharging a dope containing a polymer and a solvent from a casting die as a casting bead, the casting bead contacting on a running support to form a casting film, a step of reducing a pressure at an area near the casting bead by a decompression chamber provided at upstream from the casting die in a moving direction of the support, a step of keeping a differential pressure between inside and outside a casting section to less than 2.00 Pa. The casting section is an area partitioned from other areas by partitions, including the casting die and the decompression chamber. After that, the casting film is peeled as a film; and the film is dried. It is preferable that a volume of the casting section is in a range of 0.80 m³ to 300.00 m³. In addition, it is preferable that a wind shielding member is provided between the casting bead and the decompression chamber to shield accompanying wind, which is generated by movement of the support, toward the casting bead.

An apparatus of the present invention for producing a polymer film comprises a decompression chamber provided at upstream from the casting die in a moving direction of the support for reducing a pressure in an area near the casting bead, and partitions to partition a casting section including a casting die and a decompression chamber from other areas. A differential pressure between inside and outside the casting section is kept to less than 2.00 Pa. The present invention also includes a polymer film produced by the above-mentioned method, a polarizing plate formed to include the polymer film, and a liquid crystal display formed to include the polarizing plate.

According to the present invention, an optical film having superior thickness uniformity can be obtained by reducing thickness unevenness periodic in a casting direction of the casting film.

### BRIEF DESCRIPTION OF DRAWINGS

FIG. 1 is a schematic view of a dope producing apparatus of the present invention;

FIG. 2 is a schematic view of a film producing apparatus of the present invention;

FIG. 3 is a schematic view of a casting section in a casting chamber of the present invention;

FIG. 4 is a schematic view of periphery of a casting die in the casting section;

FIG. 5 is a schematic view of periphery of a casting die of the second embodiment;

FIG. 6 is a schematic view of periphery of a casting die of the third embodiment; and

FIG. 7 is a schematic view of periphery of a casting die of the fourth embodiment.

### BEST MODE FOR CARRYING OUT THE INVENTION

Hereinafter embodiments of the present invention are described in detail with reference to figures. However, the present invention is not limited to the following embodiments.

[Raw Materials]

A cellulose acylate is used as a polymer in this embodiment, and it is preferable that a triacetyl cellulose (TAC) is used as the cellulose acylate. The cellulose acylate, whose degree of the substitution satisfies all of following formulae (I)-(III), is more preferable. In these formulae, A is a degree of substitution of the hydrogen atom of the hydroxyl group to the acetyl group, and B is a degree of substitution of the hydrogen group to the acyl group having 3-22 carbon atoms. Preferably, at least 90 mass % of the cellulose acylate particles has diameter from 0.1 mm to 4 mm. Note that in the present invention, the polymer is not limited to the cellulose ester.

2.5≦A+B≦3.0 (I)

0≦A≦3.0 (II)

0≦B≦2.9 (III)

The cellulose is constructed of glucose units making β-1,4 combination, and each glucose unit has a liberated hydroxyl group at second, third and sixth positions. Cellulose acylate is a polymer in which part or whole of the hydroxyl groups are esterified so that the hydrogen is substituted by acyl groups. The degree of substitution for the acyl groups in cellulose acylate is a degree of esterification at second, third or sixth position in cellulose. Accordingly, when all (100%) of the hydroxyl group at the same position are substituted, the degree of substitution at this position is 1.

When the degrees of substitution for the acyl groups at the second, third or sixth positions are respectively described as DS1, DS2, DS3, the total degree of substitution for the acyl groups at the second, third or sixth positions (namely DS2+DS3+DS6) is preferably in the range of 2.00 to 3.00, particularly in the range of 2.22 to 2.90, especially in the range of 2.40 to 2.88. Further, DS6/(DS2+DS3+DS6) is preferably at least 0.28, and particularly at least 0.30, and especially in the range of 0.31 to 0.34.

The sort of acyl group to be contained in the cellulose acylate of the present invention is may be only one, and two or more sorts of the acyl group may be contained. If the number of the sorts of the acyl groups is at least two, it is preferable that one of the sorts is acetyl group. If the total degree of substitution for the acetyl groups and that for other acyl groups at the second, third or sixth positions are respectively is described as DSA and DSB, the value DSA+DSB is preferably in the range of 2.22 to 2.90, and particularly in the range of 2.40 to 2.88.

Further, the DSB is preferably at least 0.30, and especially at least 0.7. Further, in the DSB, the percentage of a substituent at the sixth position is preferably at least 20%, particularly at least 25%, especially at least 30% and most especially at least 33%. Further, the value DSA+DSB at sixth position is at least 0.75, particularly at least 0.80, and especially at least 0.85. From cellulose acylate satisfying the above conditions, a solution (or dope) having a preferable dissolubility can be prepared. Especially when non-chlorine type organic solvent is used, the adequate dope can be prepared, since the dope can be prepared so as to have a low viscosity and the filterability becomes higher.

The cellulose acylate made from either of linter and pulp cotton is usable in the embodiment, but the one from the linter cotton is preferably used.

The acyl group having at least 2 carbon atoms may be aliphatic group or aryl group, and is not restricted especially. As examples of the cellulose acylate, there are alkylcarbonyl ester, alkenylcarbonyl ester, aromatic carbonyl ester, aromatic alkylcalbonyl ester and the like. Further, the cellulose acylate may be also esters having other substituents. The preferably substituents are propionyl group, butanoyl group, pentanoyl group, hexanoyl group, octanoyl group, decanoyl group, dodecanoyl group, tridecanoyl group, tetradecanoyl group, hexadecanoyl group, octadecanoyl group, iso-butanoyl group, t-butanoyl group, cyclohexane carbonyl group, oleoyl group, benzoyl group, naphtylcarbonyl group, cinnamoyl group and the like. Among them, propionyl group, butanoyl group, dodecanoyl group, octadecanoyl group, t-butanoyl group, oleoyl group, benzoyl group, naphtyl carbonyl group, cinnamoyl group and the like are particularly preferable, and propionyl group and butanoyl group are especially preferable.

Solvent compounds for preparing the dope are aromatic hydrocarbon (for example, benzene toluene and the like), halogenated hydrocarbons (for example, dichloromethane, chlorobenzene and the like), alcohols (for example methanol, ethanol, n-propanol, n-butanol, diethylene glycol and the like), ketones (for example acetone, methylethyl ketone and the like), esters (for example, methylacetate, ethylacetate, propylacetate and the like), ethers (for example tetrahydrofuran, methylcellosolve and the like) and the like. In the present invention, the dope refers to the polymer solution and the dispersion liquid obtained by dissolving or dispersing the polymer in the solvent.

The preferable solvent compounds are the halogenated hydrocarbons having 1 to 7 carbon atoms, and dichloromethane is especially preferable. In view of physical properties such as optical properties, a solubility, a peelability from a support, a mechanical strength of the film and the like, it is preferable to use at least one sorts of the alcohols having 1 to 5 carbon atoms with dichloromethane. The content of the alcohols is preferably in the range of 2 mass. % to 25 mass. %, and especially in the range of 5 mass. % to 20 mass. % to total solvent compounds in the solvent. As concrete example of the alcohols, there are methanol, ethanol, n-propanol, isopropanol, n-butanol, and the like. It is preferable to use methanol, ethanol, n-butanol or a mixture thereof.

Recently, in order to reduce the influence on the environment, the solvent containing no dichloromethane is proposed. In this case, the solvent contains ethers with 4 to 12 carbon atoms, ketones with 3 to 12 carbon atoms, esters with 3 to 12 carbon atom, or a mixture of them. For instance, the mixture solvent of the methyl acetate, acetone, ethanol and n-butanol can be used. The ethers, ketones, esthers and alcohols may have a cyclic structure. At least one solvent compound having at least two functional groups thereof (—O—, —CO—, —COO— and —OH) may be contained in the organic solvent.

The cellulose acylate is described in detail in the Japanese patent publication No. 2005-104148, and the description of this application can be applied to the present invention. Further, as the solvent of cellulose acylate and other additives, this application discloses plasticizers, deterioration inhibitor, UV-absorbing agent, optical anisotropy controlling agent (retardation controller), dye, matting agent, peeling agent and peeling promotion agent are in detail.

[Production of Dope]

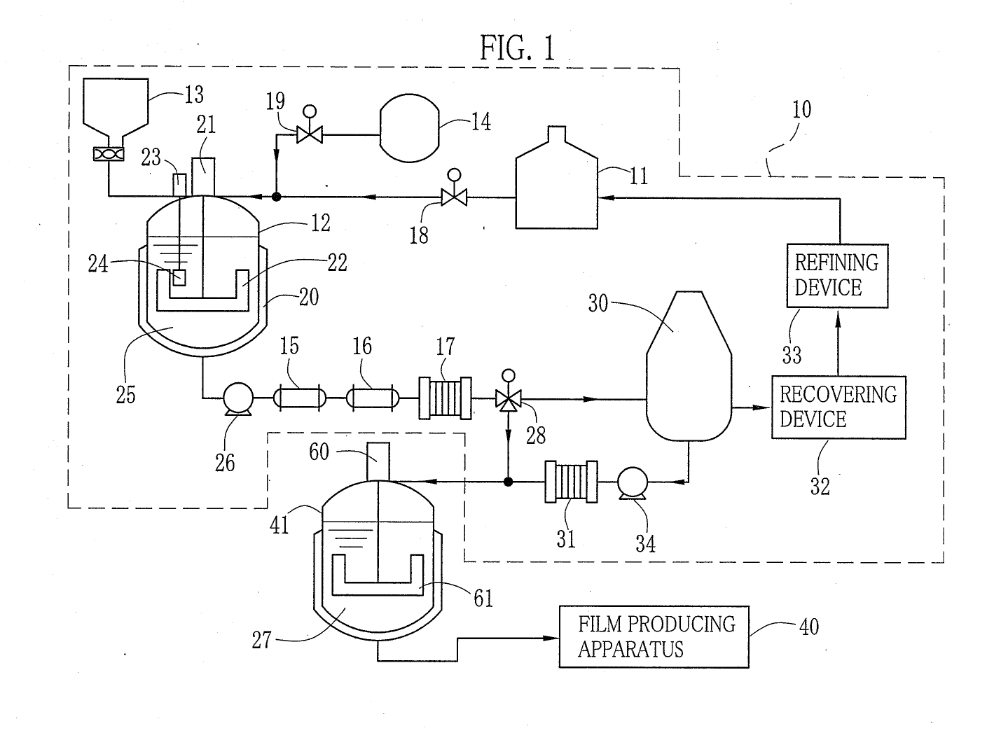

The dope is produced from the above raw materials. A dope producing apparatus 10, which is described in FIG. 1, comprises a solvent tank 11 for containing a solvent, a dissolving tank 12 for mixing the solvent and TAC, a hopper 13 for supplying the TAC and a additive tank 14 for storing the additives. The dope producing apparatus 10 further comprises a heater 15 for heating a swelling liquid described below, a temperature regulator 16 for regulating the temperature of the prepared dope 27, a first filtration device 17 for removing foreign body in the dope, flushing device 30 for adjusting the concentration of the dope, and a second filtration device 31. In addition, the dope producing apparatus 10 comprises a recovering device 32 for recovering the solvent and a refining device 33 for refining the recovered solvent. The dope producing apparatus 10 is connected to a film producing apparatus 40 through a reserve tank 41.

The dope 27 is made in the dope producing apparatus 10 by a method in the followings. At first, the solvent is transported from the solvent tank 11 to the dissolving tank 12 by opening a valve 18. Next, the adequate volume of TAC is transported from the hopper 13 to the dissolving tank 12, and the required volume of the additive liquid is transported from the additive tank 14 to the dissolving tank 12 by opening a valve 19.

There are other methods except for additives to be transported as the solution. For example, the additives can be directly transported into the dissolving tank 12 if additives are in liquid state at the normal temperature. The additives can be transported into the dissolving tank 12 by a hopper if the additive is in solid state. If plural kinds of additives are used, it can be that a solution dissolving all of them is stored in the additive tank 14, and it can be that each of solutions including single additive is stored in a separate additive tank and transported into the dissolving tank 12 through each corresponding pipe.

In the above embodiment, the order in which materials transported into the dissolving tank 12 is the solvent, the TAC and additives. However, the order is not restricted to this way. For example, after the TAO is transported into the dissolving tank 12, intended volume of the solvent can be transported. In addition, additives is not required to be preliminarily stored in the dissolving tank 12, but can be mixed into a mixture of the TAO and the solvent at the after process.

The dissolving tank 12 comprises a jacket 20 which covers the outside of the tank 12 as shown in FIG. 1, and a first stirrer 22 rotated by a motor 21. Further, preferably the dissolving tank 12 comprises a second stirrer 24 rotated by a motor 23. Note that preferably the first stirrer 22 has an anchor blade and the second stirrer 24 is an eccentric stirrer of dissolver type. Temperature inside the dissolving tank 12 is regulated by a heating medium flowing in the jacket 20. The temperature is preferably in the range of −10° C. to 55° C. By individually controlling the rotation of the first stirrer 22 and the second stirrer 24, a swelling liquid 25 in which the TAO swells in the solvent is made.

Next, the swelling liquid 25 is transported to the heater 15 by a pump 26. Preferably, the heater 15 has a jacketed pipe and a pressure device for pressurizing inside the pipe. In the heater 15, solid contents in the swelling liquid 25 are dissolved in the solvent by being heated or by being heated and pressurized (hereinafter this method is called the heating dissolution method). Note that preferably temperature of the swelling liquid 25 is heated in a range of 50° C. to 120° C. A known cooling dissolution method, in which the temperature of the swelling liquid 25 is cooled in a range of −100° C. to −30° C., is also applicable to obtain the dope 27. The heating and cooling dissolution methods are selected according to the properties of the TAO for the dissolving. A temperature of the dope is controlled to approximately room temperature by the temperature regulator 16, and then the dope is filtrated by the first filtration device 17 so that impurities are removed from the dope. Preferably the average hole diameter of a filter in the first filtration device 17 is less than 100 μm. Preferably flow rate of the filtration is equal to or more than 50 liter/hour. The dope 27 after the filtration is stored in the reserve tank 41 through a valve 28.

The method stated above, that once the swelling liquid 25 is prepared and then making the dope 27 from the swelling liquid 25, possibly needs high product cost, because longer manufacturing time is required to make the dope 27 having higher concentration of the TAC. To reduce the cost, it is preferable that the dope 27 having the TAC in lower concentration than desired concentration is prepared, and then a concentration process is performed, in which the concentration of the TAC is elevated to the desired concentration. For the concentration process being applied to the dope 27, the dope 27 filtrated in the first filtration device 17 is transported into the flushing device 30 through the valve 28, so that a part of solvent in the dope 27 is vaporized in the flushing device 30. The solvent vapor is condensed into liquid by a condenser (not shown). The liquid is recovered by the recovering device 32 and refined by the refining device 33 to be reused as the solvent for preparing the dope 27. This recycling process has an advantage in terms of cost.

The concentrated dope 27 is drawn from the flushing device 30 out by a pump 34. Further, preferably air bubbles generated in the dope 27 are removed. Any known methods to remove the air bubble are applicable (for example, ultrasonic irradiation method). Next, the dope 27 is transported to the second filtration device 31 in which impurities in the dope 27 are removed. Note that the temperature of the dope 27 when being applied these processes is preferable in a range of 0° C. to 200° C. The dope 27 is transported to and stored in the reserve tank 41. In the reserve tank 41, a stirrer 61 rotated by a motor 60 is provided to constantly stir the dope 27.

The TAC concentration of the dope 27 is preferably in a range of 5 mass % to 40 mass %, especially in a range of 15 mass % to 30 mass %, particularly in a range of 17 mass % to 25 mass %. A concentration of the additives (mainly composed of the plasticizer) is preferably in the range of 1 mass % to 20 mass % to total solid components in the dope 27. Note that methods for adding and dissolving raw materials and additives of the dope 27, filtering the dope 27, removing bubbles, and other methods in the solution casting method for producing the TAC film are explained in Japanese Patent Laid-open publication No. 2005-104148. The content of this publication can be applied to the present invention.

[Solution Casting Method]

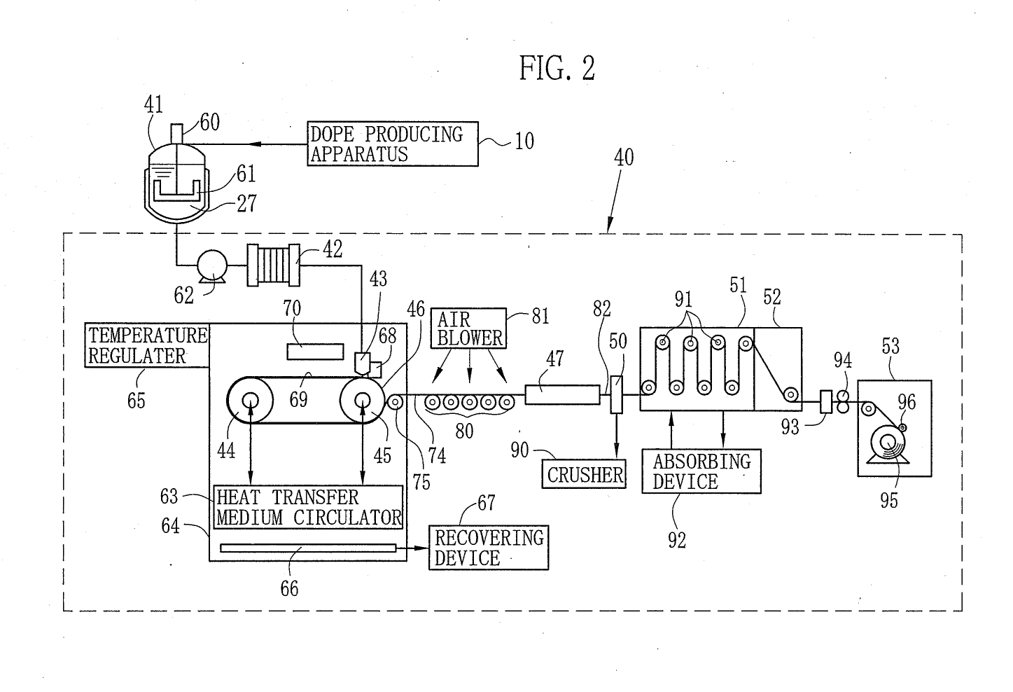

A method for producing film from the dope 27 is described below. However, the present invention is not restricted to be applied to the apparatus in FIG. 2.

The film producing apparatus 40 comprises a third filtration device 42, a casting die 43, a casting belt 46 supported by rollers 44 and 45. In downstream side from the casting belt 46, there are a tenter device 47, an edge slitting device 50, a drying chamber 51, a cooling chamber 52 and a winding chamber 53. The reserve tank 41 is connected, to the casting die 43 through a pump 62 and the third filtration device 42.

As the material of the casting die 43, a precipitation hardened stainless is preferably used. The material has coefficient of thermal expansion of at most 2×10⁻⁵ (° C.⁻¹), the almost same anti-corrosion properties as SUS316 in examination of corrosion in electrolyte aqua solution. Further, the material has the anti-corrosion properties which do not form pitting (holes) on the gas-liquid interface after having been dipped in a mixture liquid of dichloromethane, methanol and water for three months. Further, it is preferable to manufacture the casting die 43 by grinding the material which passed more than a month after casting. Thereby, the dope 27 is cast onto the casting die 43 uniformly. Accordingly, streaks and the like in the casting film 69 are prevented, as will be described later.

The surface roughness of a contacting surface of the casting die 43 to the dope is at most 1 μm, straightness is at most 1 μm/m in each direction, and the clearance of the slit is automatically controlled in the range of 0.5 mm to 3.5 mm. An end of the contacting portion of each lip to the dope was processed so as to have a chamfered radius at most 50 μm through the slit. In the die, the shear speed is preferably in the range of 1 (1/sec) to 5000 (1/sec).

Preferably, a width of the casting die 43 is about 1.1 to 2.0 times larger than a width of the product film. Preferably, a device for regulating the temperature of the casting die 43 is attached to the casting die 43 such that the casting is performed with the temperature of the casting die 43 being kept in a predetermined range. Further, preferably the casting die 43 is coat hanger type. Further, it is preferable to provide bolts (heat bolts) at predetermined intervals in the width direction of the casting die 43 for adjusting the thickness of the film, and provide an automatic thickness control mechanism using the heat bolts. When using the heat bolts in the film production, it is preferable to set the profile according to the flow volume of the pump (high-precision gear pump is preferable) 62 based on a preset program.

The casting profile can be also adjusted by a feedback control based on a measured value from a thickness measurement device (not shown) provided in the film producing device 40 (for example, an infrared thickness measurement device). Thus, in the film except of the edge portions, the difference of the thickness at any two points apart is preferably at most 1 μm, and further the difference of the minimal thickness value and the maximal thickness value in the widthwise direction is preferably at most 3 μm, especially at most 2 μm. Further, the thickness accuracy is preferably adjusted at ±1.5 μm or less.

Further, lip ends are provided with a hardened layer. In order to provide the hardened layer, there are methods of ceramic coating, hard chrome plating, nitriding treatment and the like. As the ceramic used as the hardened layer, one which is grindable but not friable, with a lower porosity and the good corrosion resistance, is preferred. In addition, the ceramic which has high adhesive property to the casting die 43 and low adhesive property to the dope is preferable. Concretely, as the ceramics, there are tungsten carbide (WC), Al₂O₃, TiN, Cr₂O₃ and the like, and especially tungsten carbide. Note in the present invention the hardened layer is preferably formed by a tungsten carbide coating in a spraying method.

A device for supplying a solvent (not shown) is preferably provided on the both edges of a die slit in order to prevent the discharged dope partially dried to be a solid. Preferably, the solvent to which the dope was dissoluble (for example, a mixture solvent whose composition is dichloromethane 86.5 mass·pct, methanol 13 mass·pct, n-butanol 0.5 mass·pct) is supplied to each bead edge and the air-liquid interface of the slit. It is preferable to supply the solvent in the range from 0.1 mL/min to 1.0 mL/min to each of the bead edges so as to prevent the impurities from being mixed in the casting film. The pump for supplying the dope preferably has a pulsation at most 5%.

Below the casting die 43, there is the belt 46 supported by the rollers 44, 45. The belt 46 moves endlessly and circulatory in accordance with a rotation of the rollers 44 and 45 by a driving device (not shown). The moving speed of the belt 46, namely a casting speed is preferably in the range of 10 m/min to 200 m/min. Furthermore, the rollers 44, 45 are connected to a heat transfer medium circulator 63 for keeping a surface temperature of the belt 46 to a predetermined value. In each roller 44, 45, there is a heat transfer passage in which a heat transfer medium of the predetermined temperature is fed, so as to keep the temperature of the rollers 44, 45 to the predetermined value. Thus the surface temperature of the belt 46 is controlled to the predetermined value. Note that the surface temperature is preferably from −20° C. to 40° C.

The width of the belt 46 is not particularly restricted, but is preferably 1.1 to 2.0 times wider than that of the dope 27. It is preferable that the length thereof is preferably 20 m to 200 m and the thickness is 0.5 mm to 2.5 mm. A surface of the belt 46 is preferably polished so as to have the surface roughness of at most 0.05 μm. The belt 46 is preferably made of stainless, and its material is SUS316 so as to have enough resistance to corrosion and strength. Moreover, the thickness unevenness of the belt 46 is preferably at most 0.5%.

The rollers 44, 45 are also usable as the support itself. In this case, preferably the rollers rotates with a high accuracy that the deviation of the rotational velocity is at most 0.2%. Preferably a surface roughness of a contacting surface of each of the rollers 44, 45 is at most 0.01 μm. The surface of the each rollers 44, 45 are processed by chrome plating so as to have the enough hardness and durability. Note that the support (the belt 46 or the roller 44, 45) preferably has minimum defect on the surface thereof. Preferably, the number of pinholes whose diameter is at least 30 μm is zero, that of the pinholes whose diameter is at least 10 μm and at most 30 μm is at most 1 per 1 m², and that of the pinholes whose diameter is less than 10 μm is at most 2 per 1 m².

The casting die 43, the belt 46 and the like are contained in a casting chamber 64. In the casting chamber 64, a temperature regulator 65 to regulate the temperature inside the chamber and a condenser 66 to condense a vaporized organic solvent is provided. A recovering device 67 to recover the condensed organic solvent is provided outside of the casting chamber 64. In addition, a decompression chamber 68 is provided at a position upstream from the casting die 43 in a moving direction of the casting belt 46, and a supply air duct 70 is provided above the casting belt 46 such that an air outlet is directed toward the moving direction of the casting belt 46. Note that the design of the components around the casting die 43 in the casting chamber 64 will be described in detail later.

A plurality of rollers 80a and an air blower 81 is provided in a transfer section 80, and the tenter device 47 and an edge slitting device 50 are provided in a position downstream from the transfer section 80. A crasher 90 is provided in the edge slitting device 50 to crush both edges of the film 82 into fragments (tips).

There are plural rollers 91 in the drying chamber 51. A recovering device 92 for adsorbing and recovering the solvent vapor is connected to the drying chamber 51. In FIG. 2, a cooling chamber 52 is provided in a position downstream from the drying chamber 51. A moisture control chamber (not shown) may be provided between the drying chamber 51 and the cooling chamber 52.

In a position downstream from the cooling chamber 52, a compulsory neutralization device (neutralization bar) 93 is provided such that the charged voltage on the film 82 may be in the range of −3 kV to +3 kV. However, the position of the neutralization device 93 is not restricted in FIG. 2. Further, a knurling roller 94 for providing a knurling with an embossing processing in the both edges of the film 82 is provided in a position downstream from the compulsory neutralization device 93. And, a winding roller 95 to wind the film 82 and a press roller 96 to control the tension on the film in winding are provided inside the winding chamber 53.

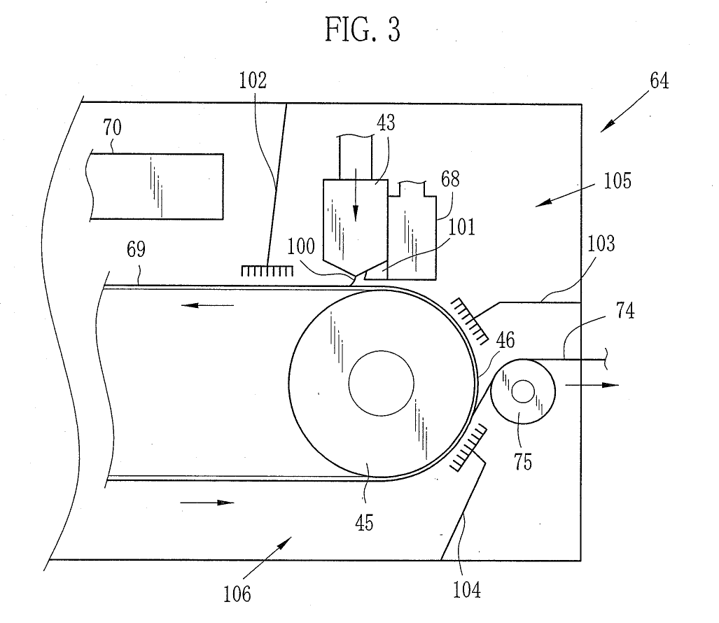

Next, the features of the present invention will be described. As shown in FIG. 3, the casting die 43 is contained in the casting chamber 64 with the roller 45, the supply air duct 70 and the roller 75.

The decompression chamber 68, a wind shielding member 101 and the casting die 43 are arranged in this order from upstream of the moving direction of the casting belt 46. A casting bead is formed between the casting die 43 and the casting belt 46, and a casting film 69 is formed on the casting belt 46. Inside the casting chamber 64, first to third partitions 102 to 104 are arranged. As the first to third partitions 102 to 104, labyrinth sealing plates are used. In this embodiment, an area surrounded by the first partition 102, the second partition 103 and walls of the casting chamber 64 is determined as a casting section 105. In the casting section 105, there are the casting die 43 and the decompression chamber 68. The other area in the casting chamber 64 is determined as a drying section 106. Between the second partition 103 and the third partition 104, where there is the roller 75, the casting film 69 is peeled off from the casting belt 46 and transported to the transfer section 80 as a wet film 74 with support of the roller 75.

In the present invention, a volume V of the casting section 105 is within a range of 0.80 m³ to 300.00 m³, preferably within a range of 1.6 m³ to 100 m³, and especially within a range of 10 m³ to 50 m³. The volume V of the casting section 105 is determined by set positions of the first and second partitions 102 and 103. When the volume V satisfies above limitation, fluctuation of air pressure, which is transmitted to inside the casting section 105 from the moving casting belt 46 and the drying section 106, is diffused and buffered. Accordingly, it is effectively prevented that thickness unevenness (such as lateral stripes) is generated on a surface of the casting bead 100 by the fluctuation of air pressure.

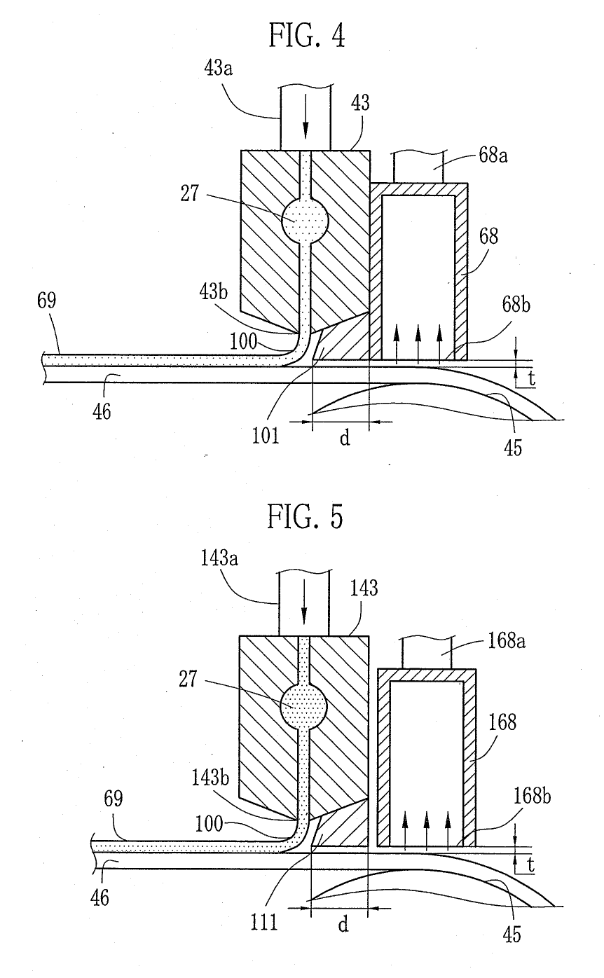

As shown in FIG. 4, when the dope 27 fed to the casting die 43 through a feeding pipe 43a is casted on the casting belt 46, the casting bead 100 having film-like shape is formed between a die slit 43b of the casting die 43 and the casting belt 46 (casting portion). At this time, if the shape of the casting bead 100 becomes unstable by the fluctuation of air pressure and so on, the casting film 69 and the product film will have the thickness unevenness. That is, the stability of the shape of the casting bead 100 is essential to produce the film having superior thickness uniformity. Accordingly, in the present invention, the decompression chamber 68 and the wind shielding member 101 are provided behind (upstream from) the casting bead 100 to reduce influences of the fluctuation of air pressure and the wind from behind the casting bead 100.

The decompression chamber 68 is composed of a hollow casing having a suction opening 68b which faces the surface of the casting belt, and a suction pipe 68a connected to the casing. The suction pipe 68a is connected to a vacuum pump (not shown). When the vacuum pump is driven, air is suctioned from the suction pipe 68a, and a pressure behind the casting bead 100 is reduced through a clearance between the wind shielding member 101 and the casting belt 46. Accordingly, the landing position of the casting bead 100 on the casting belt 46 is stabilized.

In the decompression by the decompression chamber 68, the fluctuation of air pressure in the casting section 105 is kept less than 2.00 Pa, preferably to less than 0.80 Pa, especially to less than 0.20 Pa. The fluctuation of air pressure is fluctuation of differential pressure between inside and outside the casting section 105 measured by a precision differential pressure gauge. And then the measured data is calculated by an FFT analysis to find the maximum value of the differential pressure (fluctuation of air pressure). In the present invention, Special Transducer produced by ST Institute is used as the precision differential pressure gauge, and MULTI CHANNEL DATASTATION DS-9110 produced by Ono Sokki Co., Ltd is used for the FFT analysis. When the fluctuation of air pressure is within the above-described range, influence of the fluctuation of air pressure to the casting bead 100 is sufficiently small and the casting film 69 having superior thickness uniformity can be obtained. However, when the fluctuation of air pressure is out of the above-described range, the thickness unevenness is occurred on the casting bead 100 by the fluctuation of air pressure, and the uniformity of the casting film 69 is also decreased. Note that although a suction speed of the decompression chamber 68 is not limited, it is possibly that the casting bead 100 is suctioned backward when the suction speed is too fast.

It is preferable that a jacket (not shown) is attached to the decompression chamber 68 to control the temperature inside the chamber. The temperature inside the decompression chamber 68 is not limited, but preferably at least the condensation point of the organic solvent to be used. To stabilize the shape of the casting bead 100, it is preferable that the pressure value at the backside of the casting bead 100 is controlled by the decompression chamber 68. It is preferable that the pressure value at the backside of the casting bead 100 is in a range of −2000 Pa to −10 a from that at the frontside thereof.

In addition, the wind shielding member 101 is provided behind the casting bead 1100. The wind shielding member 101 shields accompanying wind generated by the movement of the casting belt 46 and wind from the drying section 106. Accordingly, the casting bead 100 is not affected by the wind, so that the shape of the casting bead 100 is kept stabilized. The wind shielding member 101 is preferably positioned between the casting die 43 and the decompression chamber 68. In this arrangement, wind generated by suctioning air into the suction opening 68b less affects the casting bead 100.

A clearance t(mm) between the wind shielding member 101 and the casting belt 46 is preferably in a range of 0.1 mm to 30 mm, particularly in a range of 0.3 mm to 10 mm, and especially in a range of 0.6 mm to 2 mm. If the clearance t is less than 0.1 mm, there is possibility to make contact between the wind shielding member 101 and the casting belt 46, by heat expansion of the wind shielding member 101, vibration of the moving casting belt 46 and so on. If the clearance t is more than 30 mm, the shape of the casting bead 100 is possibly unstabilized by lack of the shield against the accompanying wind and the fluctuation of air pressure, and by increased amount of wind toward the casting bead 100 through the clearance from outside the wind shielding member 101.

A length d(mm) of the wind shielding member is not limited, but preferably at least 5 mm, particularly at least 30 mm, and especially at least 50 mm. If the length d of the wind shielding member 101 is less than 5 mm, the shielding performance against the accompanying wind and the fluctuation of air pressure is reduced.

As the material of the wind shielding member 101, metals such as SUS316, SUS304 and aluminum, and organic materials such as Teflon (registered trademark) and Delrin (registered trademark) can be used. In addition, the material preferably has a low coefficient of thermal expansion, to prevent the contact between the wind shielding member 101 and the casting belt 46 caused by the thermal expansion of the wind shielding member 101, because the clearance t between them is narrow. Since the wind shielding member 101 is positioned behind the casting bead, it is preferable that the wind shielding member 101 is warmed to prevent dew condensation on the surface of the wind shielding member 101, which is caused by vaporized solvent from the casting bead 100. The temperature of the wind shielding member 101 is kept preferably in a range of −20° C. to 20° C. from the boiling point of the main solvent of the dope 27, particularly in a range of −15° C. to 15° C. from the boiling point of the main solvent of the dope 27. A method for warming the wind shielding member 101 is not limited. In this embodiment, a flow passage (not shown) is formed within the wind shielding member 101 and warm water flows in the flow passage.

When the wind shielding member 101 or the decompression chamber 68 faces a position where the casting belt 46 is curved, such as a position where the casting belt is hanged on the roller 45, the face of the wind shielding member 101 facing the casting belt 46 or the suction opening 68a of the decompression chamber 68 preferably has a curved shape following the curve of the casting belt 46.

Next, an example of the method for producing the film 82 in the film producing apparatus 40 will be described in the followings. Note that the present embodiment is not limited to the following example.

The dope 27 is consistently uniformed by being stirred with the stirrer 61. The additives (plasticizer, UV-absorbing agent and the like) can be mixed in the dope 27 while the stirring. The dope 27 is transported by the pump 62 to the third filtration device 42 in which the dope 27 is filtrated, and is cast from the casting die 43 to the belt 46. A tension on the belt 46 is preferably regulated in a range 10⁴ N/m to 10⁵ N/m by the drive of two rollers 44, 45. The difference of the relative speed of the rollers 44, 45 and the belt 46 is preferably at most 0.01 m/min.

It is preferable that the velocity fluctuation of the belt 46 is at most 0.5% and the meandering of the belt 46 in widthwise direction for one rotation is at most 1.5 mm. In order to control the meandering, it is preferable that a detector (not shown) for detecting the positions of both edges of the belt 46 and a position controller (not shown) for controlling the position of the belt 46 are provided. The position controller executes feedback control based on the detected value from the detector, thereby controlling the position of the belt 46. Moreover, the positional fluctuation owing to the rotation of the roller 55 in horizontal directions of the belt 46 just below the casting die 43 is preferably regulated at most 200 p.m. The temperature in the casting chamber 64 is preferably controlled by the temperature regulator 65 in the range of −10° C. to 57° C. Furthermore, the vaporized solvent is recovered by the recovering device 32. The recovered condensed solvent is reused as the solvent for preparing the dope.

As shown in FIG. 3, inside the casting chamber 64 is divided into the casting section 105 and the drying section 106 by the first partition 102 and the second partition 103. Then as shown in FIG. 4, the dope 27 is casted on the casting belt 46 from the die slit 43b of the casting die, with forming the casting bead 100, to form the casting film 69. Note that the temperature of the casting dope 27 is preferably from −10° C. to 57° C. At this time, the decompression chamber 68 performs the decompression with satisfying the predetermined range of the fluctuation of air pressure in the casting section 105.

After having a self-supporting property, the casting film 69 is peeled as a wet film 74 from the belt 46 with support of a roller 75. Thereafter, the wet film 74 is transported to the tenter device 47 through the transfer section 80 provided with the plural rollers. In the transfer section 80, a drying air at a predetermined temperature is fed from an air blower 81 such that the drying of the wet film 74 may proceed. The temperature of the drying air is preferably in the range of 20° C. to 250° C. Note that in the transfer section 80, the rotational speed of the rollers in the upstream side is faster than those in the downstream side, so as to give tension to the wet film 74. At that time, the content of the remaining solvent is preferably in a range of 10 mass % to 200 mass % to total solid components in the film.

The content of remaining solvent in the casting film 69 means a content of remaining main solvent of the casting film 69. When plural kinds of solvents are in the casting film 69, the main solvent is the solvent whose content is the largest among the solvents in the casting film 69. The content of the remaining solvent (dry measure basis) is calculated on a following formula: Content of Solvent={(x−y)/y}×100

x: weight of a sampling film before the drying
y: weight of the sampling film after the drying
Note that in the dry measure basis, 100% is the weight of the sampling film which is completely dried to be solidified.

The wet film 74 is dried while transported in the tenter device 47, with portions thereof are held by tenter clips. Inside of the tenter device 47 is preferably partitioned into plural partitions, one of which has a temperature different from that of other partitions. Note that in the tenter device 47 the wet film 74 can be stretched in the width direction. The wet film 74 is preferably stretched in the range of 0.5% to 300% at least whether width or casting direction in whether the transfer section 80 or the tenter device 47.

The wet film 74 becomes the film 82 containing a predetermined content of the solvent in the tenter device 47. Then the film 82 is transported into the edge slitting device 50 for slitting off both edge portions of the film 82. The slit edge portions are conveyed to the crusher 90 with use of a cutter blower (not shown). The crusher 90 crushes the both edge portions into tips, which are reused for preparation of the dope in view of the cost. Note that the slitting off the both edge portions of the film 82 may be omitted. However, it is preferable to slit them off somewhere between the casting of the dope and the winding the film 82.

The film 82 is transported into the drying chamber 51 so as to be dried further. The temperature in the drying chamber 51 is not restricted but is preferably in the range of 50° C. to 160° C. The drying of the film 82 in the drying chamber 51 is made with wrapping around the rollers 91 so as to evaporate the solvent. The solvent vapor is adsorbed and recovered by the recovering device 92. The air from which the solvent vapor is removed is sent as the drying air again. Note that the drying chamber 51 is preferably partitioned into plural partitions so as to vary the drying temperature. Further, it is preferable to provide a pre-drying chamber-(not shown) between the edge slitting device 50 and the drying chamber 51 so as to make the pre-drying of the film 82. In this case, the deformation of the film 82 which is caused by the accelerate increase of the temperature of the film 82 is prevented.

The film 82 is transported into the cooling chamber 52, and cooled to an approximately room temperature. Note that a moisture control chamber (not shown) may be provided between the drying chamber 51 and the cooling chamber 52. In the moisture control chamber, an air whose moisture and temperature are controlled is fed toward the film 82. Thus a winding defect and a curl of the film 82 are prevented when the film 82 is wound.

By the compulsory neutralization device (neutralization bar) 93, charged voltage on the film 82 is regulated in the range of −3 kV to +3 kV in the transporting. In FIG. 2, the neutralization device 93 is disposed in a position downstream from the cooling chamber 52. However, the position of the neutralization device 93 is not restricted in this figure. Further, it is preferable to provide a knurling roller 94 for providing a knurling with an embossing processing. Note that the unevenness in the area in which the knurling is provided is preferably in the range of 1 μm (to 200 μm.

At last, the film 82 is wound around the winding roller 95 in the winding chamber 53. The winding is preferably made with applying a predetermined tension by the press roller 96, and it is preferable to change the tension from a start to an end of the winding little by little. The length of the film 82 to be wound is preferably at least 100 m, and a width thereof is preferably at least 600 mm, and especially from 1400 mm to 1800 mm. However, even if the width is more than 1800 mm, the present invention is effective. Further, in the present invention, the thickness of the film 82 to be produced is in the range of 30 μm to 300 μm.

The solution casting method of the present invention may be a co-casting method in which a co-casting of two or more sorts of the dopes are made such that the dopes may form a multi-layer film, or a sequentially casting method in which two or more sorts of the dopes are sequentially cast so as to form the multi-layer film. When the co-casting is performed, a feed block may be attached to the casting die, or a multi-manifold type casting die may be used. A thickness of whether upper or lowermost layer of the multi-layer casting film on the support is preferably in the range of 0.5% to 30% to the total thickness of the multi-layer casting film. Furthermore, in the co-casting method, when the dopes are cast onto the support, it is preferable that the lower viscosity dope may entirely cover over the higher viscosity dope. Furthermore, in the co-casing method, it is preferable that the inner dope is covered with dopes whose alcohol contents are larger in the bead from a die to the support.

In this embodiment, as shown in FIG. 4, the casting die 43, the decompression chamber 68 and the wind shielding member 101 are integrated. However, these components are not required to be integrated, and an only requirement for them is to be positioned behind the casting bead 100. As the second embodiment, as shown in FIG. 5, it is possible that a wind shielding member 111 and a casting die 143 are integrated and a separated decompression chamber 168 is positioned behind them.

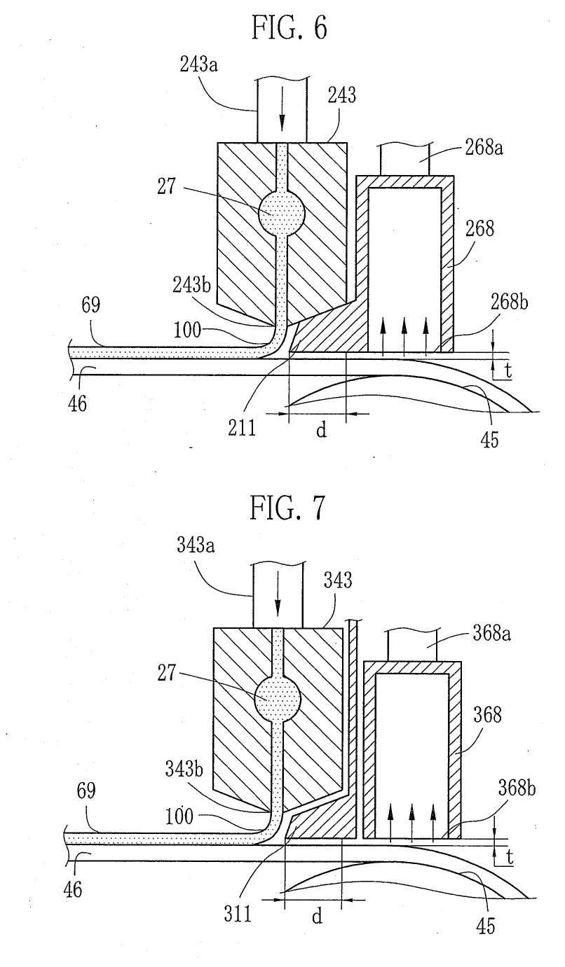

As the third embodiment, as shown in FIG. 6, it is possible that an integration of a wind shielding member 211 and a decompression chamber 268 is positioned behind the casting bead 100. In this case, it may be that the wind shielding member 211 and the decompression chamber 268 are separately manufactured and then combined by adhesion, or the decompression chamber 268 including a boot-like casing having a portion working as the wind shielding member 211 is manufactured.

As the fourth embodiment, as shown in FIG. 7, it is possible that a casting die 343, a decompression chamber 368 and a wind shielding member 311 are separately manufactured. Note that in all embodiments, it is preferable that the wind shielding member 311 and the decompression chamber 368 are positioned behind the casting bead 100, and the wind shielding member 311 is positioned between the decompression chamber 368 and the casting bead 100. According to this arrangement, the casting bead 100 receives minimized influence of the wind caused by the suction performance of the decompression chamber 368. In all embodiments, the preferable ranges of the clearance t (mm) between the wind shielding member and the casting belt, and the length d (mm) of the wind shielding member are same.

Note that the laid-open publication No. 2005-104148 teaches in detail the structure of the casting die and the support, drying conditions in each processes (such as the co-casting, the peeling and the stretching), a handling method, a winding method after the correction of planarity and curling, a recovering method of the solvent, a recovering method of film and the like. The description of the above publication may be applied to the present invention.

[Characteristics, Measuring Method]

The laid-open publication No. 2005-104148 teaches the characteristics and the measuring method of the cellulose acylate film, which may be applied to the present invention.

[Surface Treatment]

It is preferable to make a surface treatment of at least one surface of the cellulose acylate film. Preferably, the surface treatment is at least one of glow discharge treatment, atmospheric pressure plasma discharge treatment, UV radiation treatment, corona discharge treatment, flame treatment, and acid or alkali treatment.

[Functional Layer]

A primary coating may be made over at least one surface of the cellulose acylate film. Further, it is preferable to provide other functional layers for the cellulose acylate film as a film base so as to obtain a functional material. The functional layers may be at least one of antistatic agent, cured resin layer, antireflection layer, adhesive layer for easy adhesion, antiglare layer and an optical compensation layer.

Preferably, the functional layer contains at least one sort of surfactant in a range of 0.1 mg/m² to 1000 mg/m². More preferably, the functional layer contains at least one sort of lubricant in a range of 0.1 mg/m² to 1000 mg/m². Further, preferably, the functional layer contains at least one sort of matting agent in a range of 0.1 mg/m² to 1000 mg/m². Furthermore, preferably, the functional layer contains at least one sort of antistatic agent in a range of 1 mg/m² to 1000 mg/m². Methods for performing a surface treatment on the cellulose acylate film to achieve various functions and characteristics are described in Japanese Patent Laid-Open Publication No. 2005-104148 including the conditions and methods in detail, which can be applied to the present invention.

[Application]

The cellulose acylate film can be used as the protective film in a polarizing filter. To obtain a LCD, two polarizing filters, in each of which the cellulose acylate film is adhered to a polarizer, are disposed so as to sandwich a liquid crystal layer. The laid-open publication No. 2005-104148 discloses TN type, STN type, VA type, OCB type, reflection type, and other example in detail. To these types can be applied the film of the present invention. Further, the application teaches the cellulose acylate film provided with an optical anisotropic layer and that provided with antireflective and antiglare functions. Furthermore, the application supposes to provide the cellulose acylate film with adequate optical functions, and thus a biaxial cellulose acylate film is obtained and used as the optical compensation film, which can be used as the protective film in the polarizing filter simultaneously. The restriction thereof described in the laid-open publication No. 2005-104148 can be applied to the present invention.

In addition, a cellulose triacetate film (TAC film) having superior optical characteristics can be obtained according to the present invention. The TAC film can be used as a base film of a photosensitive material or a protective film in a polarizing filter. The TAC film is also used as an optical compensation film for widening a view angle of a liquid crystal display used for a TV monitor. In this case, preferably the TAC film also has the function of the protective film in the polarizing filter. Accordingly, the TAC film can be used for an IPS (In-Plane Switching) mode, an OCB (Optionally Compensatory Bend) mode, a VA (Vertically Aligned) mode and the like as well as for a conventional TN (Twisted Nematic) mode.

### Example 1

The example 1 is described in the following. However, the present invention is not limited to the example 1. Note that the detailed explanations are given only in the experiment 1.

### Experiment 1-1

The composition of the polymer solution (the dope) used in the process for producing the film is shown below.

| | |
|---|---|
| Cellulose triacetate | 100 mass · pct |
| (substitution degree of acetyl group was 2.84, viscometric | |
| average degree of polymerization was 306, moisture content was | |
| 0.2 mass · %, viscosity of 6% by mass of dichloromethane solution | |
| was 315 mPa · s, powder whose average of particle diameter was 1.5 mm | |
| and standard deviation was 0.5 mm) | |
| Dichloromethane | 92 mass · pct |
| Methanol | 8 mass · pct |
| Triphenylphosphate | 7 mass · pct |
| Biphenyldiphenylphosphate | 5 mass · pct |
| UV-absorbing agent a: | |
| 2-(2′-hydroxy-3′,5′-di-tert-butylphenyl)benzotriazol | 0.7 mass · pct |
| UV-absorbing agent b: | |
| 2-(2′-hydroxy-3′,5′-di-tert-amylphenyl)-5-chlorobenzotriazole | 0.3 mass · pct |
| citric acid ester mixture: | |
| (citric acid, monoethylester, dietylester, trietylester) | 0.006 mass · pct |
| Particles: | |
| (silicon dioxide having a diameter of 15 nm, and Mohs hardness | 0.05 mass · pct |
| of approximate 7) | |

Note that in the cellulose triacetate used in the example, content of remaining acetic acid was less than 0.1 mass. %, content of Ca was 58 ppm, content of Mg was 42 ppm, content of Fe was 0.5 ppm, content of free acetic acid was 40 ppm, and content of ion sulfate was 15 ppm. Degree of acetyl at 6^{th} position was 0.91 and that content was 32.5% of all acetyl and content extract from TAC by the acetone was 8 mass. %. A ratio of the average of molecular weight by weight to the average of molecular weight by number was 2.5. And yellow index of the obtained TAC was 1.7, haze was 0.08 and transparency was 93.5%. Tg (glass transition point measured by DSC) was 160° C. and calorific value in crystallization was 6.4 J/g. This was called cotton material TAC in below description.

The dope 27 was prepared by the dope producing apparatus 10 in FIG. 8. In the stainless dissolving tank 12 with volume 4000 L which has the stirring blade, the plural solvents were mixed and stirred so as to be the mixture solvent. Note that each of those solvents has at most 0.5 mass. % of moisture content. Flake powder of the TAC was gradually added into the dissolving tank 12 from the hopper 13. The Powder of the TAC was dispersed in the dissolving tank 12 for 30 minutes using the second stirrer 24 which is the eccentric stirrer of dissolver type (the peripheral speed of 5 m/sec) and the first stirrer 22 having the anchor blade on the center shaft (the peripheral speed of 1 m/sec). Temperature at start of the dispersion was 25° C., and that at the end of the dispersion was 48° C.

Further, the prepared additive solution in the additive tank 14 was transported into the dissolving tank 12 with volume regulated by the valve 19. A weight of the content including the additive solution in the dissolving tank was 2000 kg. After the dispersion of the additive solution is completed, high-speed stirring is stopped. Still, stirring by the first stirrer 22 is continued for 100 minutes at the peripheral speed of 0.5 m/sec. Thereby, the TAC flake was swelled to obtain the swelling liquid 25. Inside of the tank was pressurized to 0.12 MPa with nitrogen gas until the swelling. At this time the oxygen concentration inside the dissolving tank 12 was kept less than 2 vol %, therefore it was no possibility of explosion. And the content of the water was 0.3 mass. % in the swelling liquid 25.

The swelling liquid 25 was transported by the pump 26 from the dissolving tank 14 to the heater 15. For example the heater 15 is a jacketed pipe. The swelling liquid 25 was heated to 50° C. at first in the heater 15, and then heated to 90° C. under the pressure of 2 MPa, so as to be dissolved completely. At this time, the heating time was 15 minutes. Next, the temperature of the dissolved solution became 36° C. in the temperature regulator 16, and the solution was filtrated by the first filtration device 17 with a filter whose nominal pore diameter was 8 μm. Accordingly, a low concentration dope was obtained. At this time, a pressure at the primary side was 1.5 MPa and a pressure at the secondary side was 1.2 MPa in the first filtration device 17. As the material of the filter, the housing and the pipe, which reach to high temperature, HASTELLOY alloy having excellent anti-corrosion property was used.

The dope before concentration is flashed in the flashing device 30 kept at a normal pressure at 80° C. to vaporize the solvent. The solvent vapor is recovered by the condenser. The solid content concentration of the dope after the flash is 19.0 mass %. Note that the condensed solvent is recovered by the recovering device 32 to be reused as the solvent for the dope preparation. Thereafter, the recovered solvent is refined in the refining device 33 and fed to the solvent tank 11. In the recovering device 32 and the refining device 33, distillation and dehydration are carried out. In the flash tank of the flash device 30, a stirrer (not shown) with the anchor blade is provided, rotating at a peripheral speed of 0.5 m/sec to remove the foams in the flashed dope. A temperature of the dope in the flash tank is 25° C. An average residence time of the dope in the tank is 50 minutes. The dope 27 is extracted and a shear viscosity is 450 Pa·s measured at 25° C. at a shear rate of 10 (1/s).

After that, the dope 27 was exposed to weak ultrasonic waves such that the foams in the dope 27 were removed. Next, the dope 27 passed through the second filtration device 31 while being pressurized to 1.5 MPa by the pump 34. In the second filtration device 31, the dope firstly passed through a metal sintered filter whose nominal pore diameter is 10 μm and secondly passed through a sintered filter whose nominal pore diameter is also 10 μm. The primary side pressures at each filtration were 1.5 MPa and 1.2 MPa, and the secondary pressures at each filtration were 1.0 MPa and 0.8 MPa. After the filtration, the dope 27 was transported and stored into the stainless reserve tank 41 with volume of 2000 L while the temperature thereof was regulated to 36° C. The reserve tank 41 comprised the stirrer 61 which has an anchor blade on the center shaft, so as to continuously stir the content in the reserve tank 41 at the periphery speed of 0.3 m/sec.

The film 82 was produced in the film producing apparatus 40 as shown in FIG. 2. The dope 27 in the reserve tank 41 was transported into the third filtration device 42 by a high-precision gear pump 62. The pump 62 has a function to boost a pressure in the primary side thereof. The pressure in the primary side was controlled to 0.8 MPa by feedback for the upstream side of the pump 62. The volume efficiency of the pump 15 was 99.2%. And the fluctuation of the volume of discharge was at most 0.5%. The pressure of discharge was 1.5 MPa. The dope 27 passed through the third filtration device 42 was transported to the casting die 43.

Inside the casting chamber 64 was divided into the casting section 105 and the drying section 106 by the first to third partitions 102 to 104. The volume V (m³) of the casting section 105 was set to 0.50 m³ by the positions of the first and second partitions 102 and 103. However, only the decompression chamber 68 was provided behind the casting bead 100, and the wind shielding member 101 was not provided. Then the decompression chamber 68 decompresses inside the casting section 105. At this time, the maximum value of fluctuation of air pressure (Pₘₐₓ) in the casting section 105 was 3.20 Pa.

The casting die 43 was the coat hanger type, in which the bolts (the heat bolts) for adjusting the thickness of the film were provided. Each pitch of bolts was 20 mm. The casting die 43 automatically regulates the thickness of the film by the heat bolts. The heat bolts preferably set the casting profile according to the flow volume from the pump 62 by the preset program. The casting profile was adjusted by the feedback control based on the measured value from the infrared thickness measurement device (not shown) provided in the film producting device 40. Thus, in the film except of the edge portions, the difference of the thickness at any two points 50 mm apart is preferably at most 1 μm, and further the difference of the minimal thickness value and the maximal thickness value in the widthwise direction is preferably at most 3 μm. The adjustment was made such that the change of the film thickness might be reduced in the range of ±1.5% to the averaged film thickness.

The material of the casting die 43 is the precipitation hardened stainless steel. The material had coefficient of thermal expansion of at most 2×10⁻⁵ (° C.⁻¹). The surface roughness of a contacting surface of the casting die 43 to the dope was at most 1 μm, a straightness was at most 1 μm/m in each direction, and the clearance of the slit was controlled to 1.5 mm. On the lip ends of the casting die 43, the hardened layer was formed by the tungsten carbide coating in the spraying method. The end of the contacting portion of each lip to the dope was processed so as to have the chamfered radius at most 50 μm through the slit.

On the both side edges of the die slit 43b, the discharged dope is partially dried to be a solid. In order to prevent the solidification of the dope 27, mixture solvent A (dichloromethane:methanol:1-butanol=86.5 pts. mass:13 pts. mass:0.5 pts. Mass) to which the dope 27 was dissoluble was supplied at 0.5 ml/min to each bead edge and the air-liquid interface of the slit 43b. The pump for supplying the dope has a pulsation at most 5%. Further, the pressure in the rear side (or the upstream side) of the bead was decreased by 150 Pa from the front side (or the downstream side) by the decompression chamber 68.

The casting die 43 to be used was 1.8 m in width. The casting was made with regulating a flow rate of the dope 27 from the slit 43b of the casting die 43, such that the thickness of the produced film might be 80 μm and the width of the casting might be 1700 mm. In order to regulate the temperature of the dope 27 to 36° C., a jacket (not shown) is provided with the casting die 43, and a heat transfer medium was fed into the jacket. Temperature of the casting die 43 and pipes where the dope 27 flow was controlled to 36° C. while operating.

The belt 46 was an endless belt of SUS316 that was 2.1 m in width and 70 m in length. The thickness of the belt 46 was 1.5 mm and the polishment was made such that a surface roughness was at most 0.05 μm. The thickness unevenness of the belt 46 was at most 0.5%. The belt 46 was rotated by drive of the two rollers 44, 45. At this time, the tension of the belt 46 was regulated to 1.5×10⁵ N/m², and the difference of the relative speed of the rollers 44, 45 and the belt 46 was at most 0.01 m/min. Further, the velocity fluctuation of the belt 46 was at most 0.5%. The rotation was regulated with detecting the positions of both edges such that the film meandering in width direction for one rotation might be regulated to at most 1.5 mm. Further, the positional fluctuation in the horizontal direction of the lips of the casting die 43 and the belt 46 at just below the casting die 43 was at most 200 μm.

Into the rollers 44, 45 are fed the heat transfer medium so as to perform the temperature regulation of the belt 46. Into the roller 44 was fed the heat transfer medium (liquid) at 40° C. for drying and into the roller 45 was fed the heat transfer medium (liquid) at 5° C. The surface temperature of the middle portion of the belt 46 just before the casting was 15° C., and the temperature difference between both side edges was at most 6° C. Note that the belt 46 preferably had no defect on surface, and especially preferably, the number of pinholes whose diameter was at least 30 μm was zero, that of the pinholes whose diameter was from 10 μm to 30 μm was at most 1 per 1 m², and that of the pinholes whose diameter was less than 10 μm was at most 2 per 1 m². The temperature of the casting chamber 64 was kept to 35° C. by the temperature regulator 65. The dope is cast onto the belt 46 to form the casting film 69, to which the drying air of parallel flow to the casting film 69 was fed at first to dry. An overall coefficient of heat transfer between the drying air and the casting film 69 was 24 kcal/(m²·hr·° C.).

The drying air of parallel flow to the casting film 69 was fed from the supply air duct 70. On the belt 46, the oxygen concentration in the dry atmosphere was held at 5 volume %. Note that the displacement of air to Nitrogen gas was made so as to keep this oxygen concentration at 5 volume %. And in order to recover the solvent in the casting chamber 64 by condensing, the condenser 66 was provided such that the temperature at the exit thereof was set to −10° C.

When the remaining solvent in the casting film 69 reached to 50 mass. %, the casting film 69 was peeled as the wet film 74 from the casting belt 46 and supported by the roller 75. At this time, a tension on the wet film 74 was regulated to 1×10² N/m², and the ratio of velocity of the peeling to that of the running belt 46 was regulated in the range of 100.1% to 110%. The surface temperature of the peeled film 74 was 15° C. The solvent gas generated in the drying was condensed and liquefied by the condenser 66 where a temperature was −10° C. and recovered by the recovering device 67. Water content in the recovered solvent was regulated to at most 0.5%. The dried air in which the solvent was removed was heated again and reused as the drying air. The wet film 74 was transported into the tenter device 47 through the transfer section 80. In this transporting, the drying air (40° C.) was fed to the wet film 74 from the air blower 81. Note that the tension of 30 N was applied to the wet film 74 in the longitudinal direction while the wet film 74 was transported by the rollers in the transfer section 80.

The wet film 74 was transported through the tenter device 47 with the both side edge portions of the wet film 74 were held by tenter clips and stretched along the width direction. Further, the tenter device 47 was separated into three zones, and a temperature of the drying air in each zone was 90° C., 110° C. and 120° C. from the upstream. The gas composition of the drying air was that of saturated gas concentration at −10° C. Conditions of the drying zone was adjusted in such a way that remaining solvent in the film 82 was 7 mass % at the outlet of the tenter device 47.

A difference in the stretch rates between arbitrary two points which were 10 mm away from the holding portion was 10% or less, and a difference in the stretch rates between arbitrary two points which were 20 mm away from the holding portion was 5% or less. Further, a ratio of the dwastance between the clip start position and the clip release position to the dwastance between the inlet and the outlet of the tenter device 47 was 90%. The solvent vapor in the tenter device 47 was condensed and liquefied at −10° C. and recovered. The condenser was dwasposed for condensing and recovering, and the outlet temperature of the condenser was set at −8° C. The recovered solvent was reused after adjusting the mowasture content to be 0.5 mass. % or less. Thereafter, the wet film 74 was transported out of the tenter device 47 as the film 82.

The both edge portions of the film 82 were cut by the edge slitting device 50 within 30 seconds after the film 82 passed through the outlet of the tenter device 47. Both edge portions of the film 82 were cut by using a NT type cutter at 50 mm from each side edge. The cut edge portions were transported to the crusher 90 by a cutter blower (not shown). The crusher 90 crushed the edge portions into chips with an average size of 80=². The chips were used again as the material for the dope production with TAC flakes. An oxygen concentration of the tenter dryer 13 was kept at 5 vol % in an atmosphere of dry air. Further, air was substituted by nitrogen gas to keep the oxygen concentration at 5 vol %. Before drying the film 82 at a high temperature in the drying chamber 51 which will be described later, the film 82 was preheated in a preheating chamber (not shown) which supplies the drying air of 100° C.

The film 82 was dried at the high temperature in the drying chamber 51. The drying air was fed in the drying chamber 51 such that inside the chamber was partitioned into four partitions, and the respective air at 120, 130, 130 and 130° C. was fed into the respective partitions arranged in an order from the upstream side to downstream side from air blowers (not shown). The tension of the film 82 given by the roller 91 in the transporting was regulated to 100 N/m and the film 82 was dried for ten minutes so that the content of the remaining solvent in the film 82 finally became to 0.3 mass. %. A wrapping angle (arc of contact) of the roller 91 in winding the film 82 was 90° or 180°. The material of the roller 91 was aluminum or carbon steel, and the hard chrome coating was made on the surface of the roller 91. Two types of the rollers 91 were used. In the first type, the surface of the roller was smooth, and in the second type, matting process is applied on the surface of the roller by blasting. The positional fluctuation (or eccentricity) of the film 82 on the rotating roller 91 was within 50 μm.

The solvent vapor in the drying air was removed by the adsorbing device 92. The adsorbing agent was activated carbon, and the desorption was performed by the dried nitrogen. The water content in the recovered solvent was reduced to at most 0.3 mass. %, and thereafter the recovered solvent was used for the solvent for preparing the dope. The drying air includes not only the solvent vapor but also the plasticizer, the UV-absorbing agent and the like having high boiling points. These components were removed by cooling with use of a cooling device and a preadsorber, and recycled. The adsorption and desorption conditions were set so that VOC (volatile organic compounds) in the exhaust gas might become at most 10 ppm. An amount of the solvent recovered by the condensing method was approximate 90 mass. % of all vapor solvent, and the rest of the vapor solvent was mainly recovered by the adsorption.

The dried film 82 was transported into a first moisture control chamber (not shown). The drying air at 110° C. was fed into a transfer section between the drying chamber 51 and the first moisture control chamber. The air with the temperature of 50° C. and the dew point of 20° C. was fed in the first moisture control chamber. Further, in order to reduce the generation of the curling, the film 82 was transported into a second moisture control chamber (not shown). The air with the temperature 90° C. and the humidity of 70% was directly fed onto the film 82 in the second moisture control chamber.

The film 82 after the moisture thereof being controlled was cooled to equal to or less than 30° C., and both edge portions thereof were slit off or trimmed by an edge slitting device (not shown). The neutralization device (neutralization bar) 93 was provided so that the charged voltage in the film 82 in transporting was kept in a range of −3 kV to +3 kV. Further, then knurling on the both sides of the film 82 was made with use of the knurling roller 94. The knurling was given such that the film 82 was embossed from one of the both sides. An average width of the area for knurling was 10 mm, and the pressure of the knurling roller 94 was determined so that an average height of convex might be 12 μm higher than the average thickness of the film 82.

Thereafter, the film 82 was transported into the winding chamber 53 in which the temperature and the humidity were kept to 28° C. and 70%. Further, an ionizer (not shown) was provided in the winding chamber 53 so that the charged voltage in the film 82 was kept in a range of −1.5 kV to +1.5 kV. The product film 82 had 1475 mm width and 80 μm thickness. The diameter of the winding roller 95 in the winding chamber 53 was 169 mm. The tension of the film 82 was 300 N/m in the beginning of winding, and was 200 N/m in the end of winding. The total length of the wound-up film was 3940 m. One length period of weaving measurement on the winding roller 95 was 400 m, and a fluctuation range (oscillation range) in the width direction of the winding film was ±5 mm. The pressure of the press roller 96 toward the winding roller 95 was 50 N/m. In the winding, the temperature of the film 82 was 25° C., the water content was 1.4 mass, %, and the content of the remaining solvent was 0.3 mass. %.

### Experiment 1-2

The casting film 69 was formed with use of the dope 27 and the method same as Experiment 1-1. The volume V of the casting section 105 was set to 0.73 m³. At this time, Pₘₐₓ in the casting section 105 was 2.20 Pa.

### Experiment 1-3

The casting film 69 was formed with use of the dope 27 and the method same as Experiment 1-1. The volume V of the casting section 105 was set to 0.91 m³. At this time, Pₘₐₓ in the casting section 105 was 1.60 Pa.

### Experiment 1-4

The casting film 69 was formed with use of the dope 27 and the method same as Experiment 1-1. The volume V of the casting section 105 was set to 1.51 m³. At this time, Pₘₐₓ in the casting section 105 was 0.90 Pa.

### Experiment 1-5

The casting film 69 was formed with use of the dope 27 and the method same as Experiment 1-1. The volume V of the casting section 105 was set to 4.11 m³. At this time, Pₘₐₓ in the casting section 105 was 0.79 Pa.

### Experiment 1-6

The casting film 69 was formed with use of the dope 27 and the method same as Experiment 1-1. The volume V of the casting section 105 was set to 10.30 m³. At this time, Pₘₐₓ in the casting section 105 was 0.30 Pa.

### Experiment 1-7

The casting film 69 was formed with use of the dope 27 and the method same as Experiment 1-1. The volume V of the casting section 105 was set to 30.10 m³. At this time, Pₘₐₓ in the casting section 105 was 0.10 Pa.

### Experiment 1-8

The casting film 69 was formed with use of the dope 27 and the method same as Experiment 1-1. The volume V of the casting section 105 was set to infinite (∞) such that no partition was provided near the casting die 43 and the casting section 105 was open to the outside air. At this time, Pₘₐₓ in the casting section 105 was 0.02 Pa.

### Experiment 1-9

The casting film 69 was formed with use of the dope 27 and the method same as Experiment 1-1, except for that the film thickness was set to 40 μm. The volume V of the casting section 105 was set to 30.10 m³. At this time, Pₘₐₓ in the casting section 105 was 0.10 Pa.

### Example 2

### Experiment 2-1

The dope 27 was formed with use of the materials and the method same as Example 1, then the dope 27 was casted from the casting die 43 to the casting belt 46 to form the casting film 69. The volume V of the casting section 105 was set to 0.91 m³. In addition, as shown in FIG. 4, the wind shielding member 101 and the decompression chamber 68 were provided behind the casting bead 100. At this time, Pₘₐₓ in the casting section 105 was 0.90 Pa. Note that the wind shielding member 101 was made of SUS having length d of 300 mm. The clearance t between the wind shielding member 101 and the casting belt 46 was set to 1.5 mm.

### Experiment 2-2

The casting film 69 was formed with use of the dope 27 and the method same as Example 1. The volume V of the casting section 105 was set to 0.91 m³, by the first and second partitions 102 and 103. The decompression chamber 68 was provided behind the casting die 43, but the wind shielding member 101 was not provided. At this time, Pₘₐₓ in the casting section 105 was 0.90 Pa.

The thickness unevenness of the casting film 69 at each Pₘₐₓ measured in Example 1 and Example 2 was measured with FILM THICKNESS TESTER KG601 produced by Anritsu Corp. When the percentage of the film thickness fluctuation generated with periodicity of at least 3 Hz was less than 0.30 of the film thickness, the estimation was E (excellent), in which. When the percentage of the film thickness fluctuation was less than 0.8%, the estimation was G (good). When the percentage of the fluctuation was less than 1.5%, the estimation was A (acceptable to some applications). And when the percentage of the fluctuation was at least 1.5%, the estimation was U (unusable).

The manufacturing conditions in the casting section 105 and the estimations of the thickness unevenness in Example 1 and Example 2 are respectively shown in Table 1 and Table 2.

TABLE 1

| | | V | Pₘₐₓ | | |
|---|---|---|---|---|---|
| | | (m³) | (Pa) | Est. | Remarks |
| Exa. 1 | Exp. 1-1 | 0.50 | 3.20 | U | — |
| | Exp. 1-2 | 0.73 | 2.20 | U | — |
| | Exp. 1-3 | 0.91 | 1.60 | A | — |
| | Exp. 1-4 | 1.51 | 0.90 | A | — |
| | Exp. 1-5 | 4.11 | 0.79 | G | — |
| | Exp. 1-6 | 10.30 | 0.30 | G | — |
| | Exp. 1-7 | 30.10 | 0.10 | E | — |
| | Exp. 1-8 | ∞ | 0.02 | E | Open system |
| | Exp. 1-9 | 30.10 | 0.10 | E | — |

Est.: Estimation of the thickness unevenness of the casting film
Open system: The casting section was open to the outside air

TABLE 2

| | | | V | Pₘₐₓ | |
|---|---|---|---|---|---|
| | | Shield | (m³) | (pa) | Est. |
| Exa. 2 | Exp. 2-1 | with | 0.91 | 0.90 | E |
| | Exp. 2-2 | without | 0.91 | 0.90 | A |

Shield: Wind shielding member provided behind the casting bead
Est.: Estimation of the thickness unevenness of the casting film

In Example 1, the decompression chamber 68 was provided behind the casting die 43 and the casting bead 100, and the casting section 105 including the casting die 43 and the decompression chamber 68 was determined by the first and second partitions 102 and 103. In Experiments 1-1 to 1-9, the volume V of the casting section 105 and the maximum value of fluctuation of air pressure (Pₘₐₓ) was varied. When the surface of the casting film 69 was observed, it was confirmed that there was large amount of thickness unevenness including considerable number of lateral stripes (U) in Experiment 1-1 and Experiment 1-2. In Experiment 1-3 and Experiment 1-4, there was certain amount of thickness unevenness, but the amount is smaller than that in Experiment 1-1 and Experiment 1-2 (A). In Experiment 1-5 and Experiment 1-6, the thickness unevenness was almost not observed and the thickness uniformity of the film was high (G). In Experiment 1-7, Experiment 1-8 and Experiment 1-9, the thickness unevenness was not observed and the thickness uniformity of the film was quite high (E).

Accordingly, it was found that making the volume V of the casting section 105 as large as possible and setting the maximum value of fluctuation of air pressure (Pₘₐₓ) in the casting section 105 to less than 0.80 Pa are the conditions for forming the casting film 69 with few amount of thickness unevenness (few numbers of the lateral stripes).

In Example 2, the volume V of the casting section 105 was set to 0.91 m³, and Pₘₐₓ in the casting section 105 was set to 0.9 Pa, as the conditions for forming the casting film 69 with few amount of thickness unevenness which was found by Example 1. In this condition, change of the thickness unevenness according to presence and absence of the wind shielding member 101 was checked. In the result, when the wind shielding member 101 was provided behind the casting bead 100 (Experiment 2-1), the lateral stripes was almost not observed and the thickness uniformity of the film was quite high (E). However, when the wind shielding member 101 was omitted (Experiment 2-2), there was certain amount of the lateral stripes and the thickness uniformity of the film was acceptable to some applications (A). Accordingly, it was found that the existence of the wind shielding member 101 behind the casting bead 100 reduces the thickness unevenness.

From these examples, it is found that the effective means to form the casting film with reduced the thickness unevenness (lateral stripes) are as follows: providing the decompression chamber behind the casting die (that is, behind the casting bead); partitioning the casting section from other areas by the partitions to include the casting die and the decompression chamber; and adjusting the volume V (m³) of the casting section and the Pₘₐₓ (Pa) of fluctuation of air pressure in the casting section. The value of V is in the range of 0.80 m³ to 300.00 m³, and the value of P is less than 2.0 Pa. Note that it is most preferable that the value of V is infinite in view of reducing the lateral stripes. However, there is a need to provide the casting chamber to prevent emission of the solvent into the outside air. When the volume of the casting chamber is 300 m³, the desired effect of the present invention is sufficiently obtained.

In addition, it is confirmed that when the wind shielding member is provided behind the casting bead to shield the wind from behind the casting bead, the thickness unevenness on the surface of the casting film is reduced. From such casting film with reduced thickness unevenness, the polymer film with superior uniformity can be produced.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

### INDUSTRIAL APPLICABILITY

The present invention is preferably applicable to a polymer film, especially a-polymer film used for optoelectronics, such as a protective film for a polarizing filter, a retardation film, a transparent conductive film and the like.

1. A method for producing a polymer film, comprising steps of:
discharging a dope containing a polymer and a solvent from a casting die as a casting bead, said casting bead contacting on a running support to form a casting film;
reducing a pressure at an area near said casting bead by a decompression chamber provided at upstream from said casting die in a moving direction of said support;
a step of keeping a differential pressure between inside and outside a casting section to less than 2.00 Pa, said casting section being an area partitioned from other areas by partitions and including said casting die and said decompression chamber;
peeling said casting film as a film; and
drying said film.

2. A method for producing a polymer film claimed in claim 1, a volume of said casting section is in a range of 0.80 m³ to 300.00 m³.

3. A method for producing a polymer film claimed in claim 1, a wind shielding member being provided between said casting bead and said decompression chamber to shield accompanying wind, which is generated by movement of said support, toward said casting bead.

4. An apparatus for producing a polymer film, comprising:
a decompression chamber provided at upstream from said casting die in a moving direction of said support, for reducing a pressure in an area near said casting bead; and
partitions to partition a casting section including a casting die and a decompression chamber from other areas, differential pressure between inside and outside said casting section being kept to less than 2.00 Pa.

5. An apparatus for producing a polymer film claimed in claim 4, a volume of said casting section is in a range of 0.80 m³ to 300.00 m³.

6. A polymer film produced by said method claimed in one of claims 1 to 3.

7. A polarizing plate formed to include said polymer film claimed in claim 6.

8. A liquid crystal display formed to include said polarizing plate claimed in claim 7.
